(19) United States
(12) Patent Application Publication
(10) Pub. No.: US 2014/0143751 A1
(43) Pub. Date: May 22, 2014

(54) Methods and Arrangements for Processing and Presentation of Information

(71) Applicant: Juan Carlos Barinaga, Houston, TX (US)

(72) Inventor: Juan Carlos Barinaga, Houston, TX (US)

(21) Appl. No.: 14/082,172

(22) Filed: Nov. 17, 2013

Related U.S. Application Data
(60) Provisional application No. 61/727,676, filed on Nov. 17, 2012.

(51) Int. Cl. G06F 9/44

(52) U.S. Cl. CPC G06F 8/00
USPC 717/104

(57) ABSTRACT

An embodiment may correspond to a computing platform that supports a new computing paradigm, called the resolution-centered paradigm, also referred to as a definition-centered paradigm.

### BACKGROUND

Computing platforms form the basis by which higher level computing processes are defined and executed. Evolving computing paradigms have necessitated the corresponding evolution of computing platforms which support those paradigms, such as the imperative, object oriented and functional paradigms.

### BRIEF DESCRIPTION OF THE DRAWINGS

FIG. 1 DCP binding as an overlay computing platform

FIG. 2. Class Relationships

### DETAILED DESCRIPTION OF EMBODIMENTS

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

An embodiment may correspond to a computing platform which supports a new computing paradigm, called the resolution-centered paradigm, also referred to as a definition-centered paradigm.

The resolution-centered paradigm (RCP) or definition-centered paradigm (DCP) can provide the basis for computing assemblies that are shorter and more powerful than those of current paradigms alone. It can also be able to execute code from current paradigms.

RCP can be implemented as a discrete computing platform or as an overlay on top of existing computing platforms, such as .Net and JVM, allowing interoperability with capabilities of the overlayed platform.

A computing platform which supports RCP includes:

Models.

Code is separate into discrete models, which have a tree structure. Each model is composed of constituent objects, of which there are two base types: Concepts and Relations. Model layers alternate between Concepts and Relations. Each constituent object within the hierarchy is executed in the context of its parent constituent. For example, the top constituent of a model could be a matrix (concept), which has segments as children (relations), which would then be followed by other concepts.

Definitions:

Each constituent within a model has a definition, accessible as an expression. For example, a given matrix object (which is a type of Concept) could be defined with NewMatrix(Volume{}*Price{}). A relation's definition is always with regards to a base concept, while a concept's definition can be independent. The definition enables a constituent to be reproduced in other contexts, and allows its precedent/dependent relationships to be detected by the RCP platform. The definition also allows constituents to be dynamic, both in content and in execution. The arguments within the definition of a concept may be set using expressions which become the definitions of descendant concepts.

Resolutions.

The constituents of a model can be resolved, a process which updates their values based on their definitions. The resolution sequence of constituents is managed by the RCP platform, where the resolution of individual concepts can be deferred until precedents needed for their execution have been updated. Exceptions encountered during an executable object's execution causes the executable to acquire an exception. Resolution of a set of constituents may cause output to be displayed manually (such as printing to the console), or automatically through methods inherent to the platform.

Expressions.

A Models is composed from an expression, which is a type of concept, that may contain multiple levels of subexpressions. Evaluations of expressions are also concepts, and may be conducted within a given context. As the expressions within the platform are also concepts, they are recompiled real time according to the type system of the RCP platforms.

Types:

Each constituent has an associated type, where the type object is a concept. These type objects may be in parallel with type objects of the underlying platform. Types can include features of object oriented platforms such as inheritance and encapsulation. Methods are also types.

### Advantages of Some Embodiments

The benefits of the resolution centered paradigm include:

Simplicity.

Reduced code through dynamic computing abilities. Ability to think of concepts independently, with their definition, instead of their interdependent execution sequences. The system manages the resolution of concepts based on their interdependencies.

Modularity.

Concepts can be added/copied onto existing models or new models. Since the concept's definition encapsulates its processes and execution and interdependencies can be detected, this significantly reduces the effort.

Compatibility.

The paradigm is compatible with existing paradigms, and can be constructed as an overlay to other platforms such as the object oriented platforms of .Net and JVM.

### Embodiments May at Least Comprise the Following

Constituents:

A method for creating a constituent object, where the instance includes a method to access the definition which the executable is based from, a method to access the parent constituent of the instance, the ability to serve as the parent for other constituent instances contained within it and a method to execute the instance.

### Concepts:

A method for specifying parameters for constituent instances, where the constituent instance can fulfill the given parameter with an expression that evaluates to a given type

An method for accessing the definitions which fulfill specifications to an executable method, where the arguments are concepts

A method for resolving a set of instances, whereby the sequence of resolving of the instances is modifiable based on dependencies among them

### Blueprints:

A method for creating an instance of a Blueprint type where the Blueprint type is a type of Concept, each blueprint object specifies the context type which instances of the blueprint can be made within, and where the blueprint includes specifications which must be fulfilled by its instances

A method for creating instances of a blueprint where each specification of the blueprint is fulfilled by an expression for each given instance

### Specifications:

A method for creating an instance of a Specification type, where a Specification is a type of Concept, and each tool instance specifies a name identifier, and the resolve type with each fulfillment expression of the tool must meet

A method for specifying a default expression for a specification's fulfillment

### Expressions:

A method for creating an instance of an Expression type, where an Expression is a type of Concept that can contain text code with identifiers and where an expression may contain descendant subexpressions which fulfill fragments of the higher level expression

A method for specifying a type of expression (aka EverExpression) where the evaluation value result is always a type of EverExpression

A method for specifying supplemental expressions (aka Supplements) within an expression which are evaluated after an evaluation of the expression and do not impact the result of the expression's evaluation

A method for specifying an attribute of a method parameter such that arguments passed to instances of the method should be passed as unevaluated expressions of a specified resolve type

### Bodies and Bases:

A method for creating an instance of a Body type, where a Body is a type of Concept which contains a Basis and has a cell for each permutation of the dimension cells within its basis which can contain a value of a given type

A method for creating an instance of a Basis type, where a Basis is a type of Concept which contains a set of zero, one or more unique Dimensions in a specific sequence

A method for creating an instance of a Dimension type, where a Dimension is a type of Body, a type of Basis, is its own Basis, and can contain zero, one or more cells.

### Relations:

A method for creating a relation object, where a relation is a type of constituent and each relation is made as a descendant of a corresponding concept object

A method for creating an instance of a Segment type, where a Segment is a type of Relation which can serve as the parent to Concepts of a Body object

A method for specifying an association between two basis objects, where each element of the first basis corresponds to a segment of the second basis

A method for converting a segment from one basis to another basis through the use of association relationships

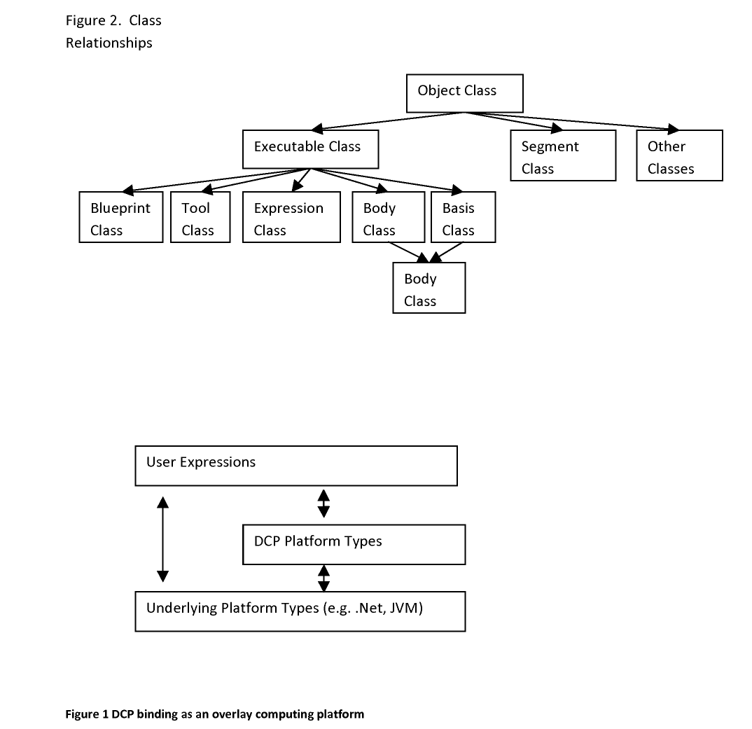

Another embodiment is implemented as a program product for implementing systems and methods described with reference to FIGS. 1-2. Some embodiments can take the form of an entirely hardware embodiment, an entirely software embodiment, or an embodiment containing both hardware and software elements. One embodiment is implemented in software, which includes but is not limited to firmware, resident software, microcode, etc.

Furthermore, embodiments can take the form of a computer program product (or machine-accessible product) accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The logic as described above may be part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product.

I claim:

1. A method for creating a constituent object, where the instance includes a method to access the definition which the executable is based from, a method to access the parent constituent of the instance, the ability to serve as the parent for other constituent instances contained within it and a method to execute the instance.
